(19) United States
(12) Patent Application Publication
(10) Pub. No.: US 2002/0110152 A1
(43) Pub. Date: Aug. 15, 2002

(54) Synchronizing encoder - decoder operation in a communication network

(76) Inventor: Silvain Schaffer, Ramat Hasharon (IL)

Correspondence Address: BROWDY AND NEIMARK, P.L.L.C., 624 NINTH STREET, NW, SUITE 300, WASHINGTON, DC, 20001-5303, US

(21) Appl. No.: 09/782,148

(22) Filed: Feb. 14, 2001

(51) Int. Cl. H04J 3/06

(52) U.S. Cl. 370/503; 370/522

(57) ABSTRACT

A method is provided for use in transmission of audio signals over an IP network. By this method the synchronous operation of a pair of interconnected an audio encoder and an decoder implementing at least one audio algorithm is coordinated, by transmitting a message indicating that a synchronous reset is required.

### FIELD OF THE INVENTION

The present invention relates to telecommunication systems in general, and in particular to the transmission of compressed signals in telecommunication systems.

### BACKGROUND OF THE INVENTION

In recent years, various techniques are being implemented in order to save on required bandwidth, techniques which achieve toll-quality or near toll quality speech while using compressed telecommunication transmissions. These techniques typically involve the use of coding algorithms that allow reducing the bandwidth requirement of 64 kb/s for non-compressed PCM channel, for speech and audio services. One such example is the CS-ACELP algorithm which enables reducing the bandwidth requirement to 8 kb/s. Naturally, in order to use such coding algorithms, both ends of the transmission path must be provided with the ability to code and decode successfully the transmissions. One way of achieving this requirement is to use equipment of a single proprietary at both ends of the transmission path. However, with the ever increasing use of IP networks, this solution seems less and less attractive. Another possible solution is the application of international standards that allow compatibility of different types of equipment located along any transmission path.

The international standard for the coding algorithm CS-ACELP was published on March 1996 as International Telecommunication Union (ITU-T) Recommendation G.729. However, there are some problems associated with the implementation of such algorithm.

Section I.3 in Annex I of I.366.2 specifies a procedure of resetting the encoder and decoder in the case that other types of algorithms such as G.722, G.726, G.727 or G.728 are used. In accordance with the solution provided therein, when the first active voice packet following a generic Silence Insertion Descriptor (to be referred to hereinafter as “SID” ) packet selects an adaptive audio algorithm—e.g. G.722, G. 726, G.727 or G.728, the encoding and decoding of that packet shall be performed starting from an audio coder state that has been reset to its specified initial values. By following the solution provided, the Recommendation further states that “This eliminates glitches that could otherwise occur if the transmitter's state were to diverge during the silence, when active voice packets are not being sent and the receiver's state is not being updated. Resetting both encoder and decoder in this way maintains a synchronized state and initiates a fresh adaptation for each talk spurt, unbiased by the previous one.” However, this solution is not acceptable when using a more complex audio algorithm such as the G.729.

In Annex B of G.729 a voice activity detector and comfort noise generator are defined for use with Recommendations G.729 or G.729 Annex A. The background noise is encoded as Silence Insertion Descriptor as defined in I.366.2 Annex H. The encoder and decoder algorithmic states are updated during silence intervals by means of G.729 SID packets.

From the reasons stated above, it would seem advantageous from a speech quality point of view not to synchronously reset the encoder and decoder prior to each speech burst for G.729 audio algorithm. This conclusion is further supported by the fact that such synchronization is not required because during silent periods as defined in Annex B of G.729 there is no channel disconnection between the encoder and decoder algorithm.

However, there are still cases where it is required to synchronize the encoder and decoder algorithms of G.729, e.g. whenever a new pair of encoder and decoder is selected. In a non-switched trunking mode, this situation happens after each system's reset, but in a switched trunking mode, this situation typically happens for each new call. These switched and non-switched trunking modes are defined in ATM forum document af-vtoa-0113.000.

### SUMMARY OF THE INVENTION

It is therefore an object of the present invention to provide a method for improving the operation of a network in which audio compression algorithms are used.

It is yet another object of the present invention to provide a system and an apparatus operative for encoding/decoding telecommunication operative in IP networks.

Other objects of the invention will become apparent as the description of the invention proceeds.

In accordance with the present invention there is provided a method for use in the transmission of audio signals over an IP network and is directed for coordinating the synchronous operation of a pair of interconnected audio encoder and decoder implementing at least one audio algorithm, where this method comprises the transmission of a message indicating that a reset of the at least one audio algorithm is required for the purpose of synchronization (a synchronous reset message).

According to a preferred embodiment of the invention, the at least one audio algorithm is an audio algorithm having built-in silence suppression. The term “audio algorithm having built-in silence suppression” as used herein, should be understood to encompass all audio algorithms that incorporate encoding of background noise during silence elimination period and its decoding as comfort noise.

According to a preferred embodiment of the invention, the method is provided for coordinating synchronous operation of the encoder and decoder in at least one of the following events:

a. a new communication link between the encoder and decoder is established;

b. a link failure condition;

c. a pre-determined period of time has lapsed since a previous synchronous reset took place provided event (i) and (ii) have not occurred within this pre-determined period of time.

Therefore, the method provided by the present invention allows the decoder to track the encoder's operation (mutatis mutandis), thus allowing a smoother operation of the telecommunication network to which they are connected.

By another preferred embodiment of the invention, the coordination of the synchronous operation of the encoder and the decoder is done by resetting the operative audio algorithm to its pre-defined values.

In accordance with another preferred embodiment of the invention, the method is provided for a pair comprising an audio encoder and an audio decoder, both adapted to utilize at least one audio algorithm and preferably that algorithm allows encoding of background noise during silence elimination. Examples of such algorithms are G.723.1, G.729, G.729A, GSM full rate, GSM half rate and GSM enhanced rate, and the like. Also, the packetized networks may be for example such networks wherein messages are transmitted non-synchronously to the payload transmission.

According to yet another preferred embodiment of the invention, the method provided for a case of establishing a new communication link between the encoder and decoder, comprises the following steps:

a. establishing a path for a new communication transmission;

b. preventing the encoder from transmitting traffic information for a first pre-defined period of time;

c. adjusting the encoder's audio algorithm to its pre-defined values during said first pre-defined period of time, preferably by resetting the encoder's operative audio algorithm;

d. transmitting towards the decoder at least one message for synchronous reset to the decoder;

e. following the receipt of said at least one message for synchronous reset, adjusting the decoder audio algorithm currently operative to its pre-defined values; and

f. allowing the encoder to re-process and re-transmit a new traffic information type of transmission after said first pre-defined period of time has lapsed.

According to a more preferred embodiment, the method further comprises:

g. in response to the receipt of said at least one message for synchronous reset by the decoder, transmitting an acknowledgement towards the encoder end;

h. in the event that this acknowledgment is not received within a second pre-defined period of time, repeating steps (ii) to (vii).

By a still a preferred embodiment of the invention, a message for synchronous reset comprises at least one reset code message, preferably, three reset code messages. More preferably, the message for adjustment/reset and/or any other messages associated with the procedures described above are transmitted as control messages in RTP packets.

In accordance with yet another preferred embodiment of the invention, the period in which the encoder is prevented from transmitting traffic information to the decoder, extends for N algorithmic frames. This will allow the transmission of N reset code messages at intervals that correspond to the frames' length of the operative audio algorithm. This allows overcoming of IP network packet loss conditions.

According to yet another embodiment of the invention, coordinating the synchronous operation of the pair of interconnected audio encoder and decoder is carried out by transmitting either an in-band or out of band request for adjustment to the decoder.

In accordance with another aspect of the invention, there is provided an encoding/decoding device provided with means of implementing at least one audio algorithm, preferably an algorithm having built-in silence suppression. This encoding/decoding device is adapted for transmission of audio signals over an IP network, and is capable of resetting the at least one audio algorithm to its initial pre-defined values in response to a synchronous reset message received by a receiver associated therewith.

According to yet another aspect of the invention there is provided a system adapted for transmission of audio signals over an IP network. The system comprises at least one pair of interconnected compressing/decompressing devices one of which is operative as an audio encoder and the other as an audio decoder, and at least one message transmitter capable of transmitting a synchronous reset message, wherein the audio encoder is reset along with the transmission of the synchronous reset message and wherein the audio decoder is reset in response to receiving the synchronous reset message.

### BRIEF DESCRIPTION OF THE DRAWINGS

FIG. 1 illustrates the method provided by the present invention.

### DETAILED DESCRIPTION OF THE INVENTION

The method provided by the present invention for adjusting the audio encoder and decoder algorithms used to their pre-defined values, can in fact be applied each time a disconnect condition between encoder and decoder occurs. In addition, the algorithmic coordination should preferably be performed whenever a change in algorithms occurs (e.g. from a speech algorithm to VBD algorithm).

As was previously explained, the algorithmic adjustment should be performed to ensure synchronous operation between the encoder and the decoder (i.e. the encoding and decoding of the first packet after the adjustment shall be started from the same audio codec state that has been adjusted to its pre-defined values).

Preferably, the algorithmic coordination of the audio encoder and decoder to their pre-defined values may be carried in each one of the following situations:

System initialization

New call (only for “Switched trunking mode”)

Change of algorithm (e.g. VBD to Speech, Fax to Speech etc.)

The algorithmic coordination procedure is uni-directional and is performed from the transmitter to the receiver. This algorithmic coordination procedure may be initiated locally or alternatively may be requested by the far end.

Control Messages for Algorithm Reset Procedure

Three application control messages are supported in order to implement the Algorithm Reset procedure:

“ForwardReset_request”, “ForwardReset_confirm” and “BackwardReset_request”.

The “ForwardReset_request” message is real time oriented and is implemented as a control message using RTP packets.

As known in the art, there is provided an optional Header Extension mechanism for Real-time Transport Protocol (“RTP”). In accordance with this mechanism, if the X bit in the RTP header is one, a variable-length header extension is appended to the RTP header, following the CSRC list if present. The header extension contains a 16-bit length field that counts the number of 32-bit words in the extension, excluding the four-octet extension header (therefore zero is a valid length). Only a single extension may be appended to the RTP data header. To allow multiple interoperating implementations independently with different header extensions, or to allow a particular implementation with more than one type of header extension, the first 16 bits of the header extension are left open for distinguishing identifiers or parameters. The format of these 16 bits is to be defined by the profile specification under which the implementations are operating.

In accordance with the present invention, whenever one of the Reset Procedure messages is transmitted, the Extension bit X in the fixed RTP header is set to one.

If the X bit in the RTP header is one, a variable-length header extension is appended to the RTP header, following the CSRC list if present. The header extension contains a 16-bit length field that counts the number of 32-bit words in the extension, excluding the four-octet extension header (therefore zero is a valid length). The 16-bit length field is set to zero. This leaves 16 bits for control message type encoding in the four-octet extension header.

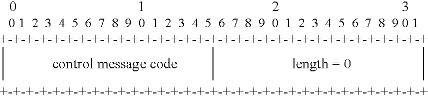

As will be appreciated by those skilled in the art, this invention may be incorporated in H.225 the generic requirements of the Algorithm Reset Procedure for audio algorithms with built-in silence suppression (e.g. for G.729/G.729A with Annex B).

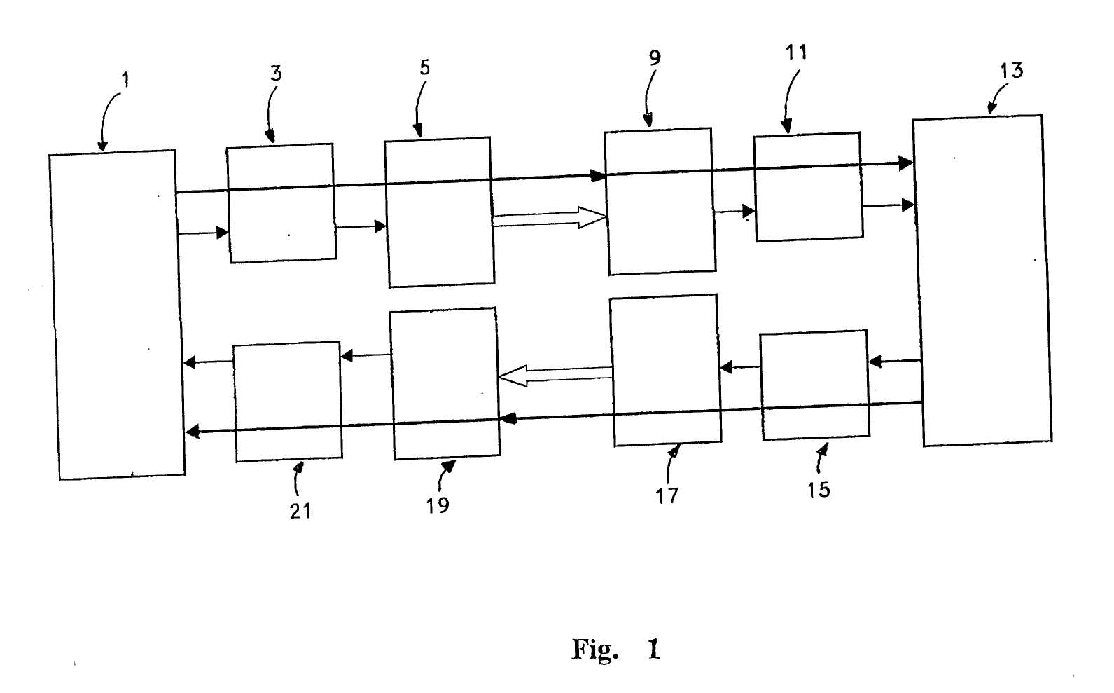

FIG. 1 illustrates an example of the algorithm invention. For the sake of simplifying the description, the exemplified procedure is divided into a number of blocks, and their description is provided hereinafter. However, as any person skilled in the art would appreciate, there are number of other options of carrying out the invention, and that the examples described herein are only for illustrative purposes.

### EXAMPLE 1

Under normal operating conditions, PCM signals are transmitted from User 1 at the rate of 64 kbps to encoder 3. The signals are then encoded and transmitted in their encoded form signals to RTP packetizer 5. The packets are delivered to RTP 9 operating as a de-packetizer, which in turn de-packetizes the transmitted packets and transmits the output to decoder 11. Decoder 11 converts the encoded transmission into its PCM signals and transmit them to User 13.

When a coordination procedure is required, the algorithm used by encoder 3 is adjusted to its pre-defined values (i.e. initial state). Simultaneously with the above coordination procedure, Media Control (“MC”) associated with User 1, bypasses encoder 3 and transmits a number of reset code messages via RTP packetizer 5 towards the far end, to RTP packetizer 9.

Upon receipt of the reset code packets, RTP packetizer 9 transmits a reset code message to MC associated with User 13, which in turn performs a similar coordination procedure to decoder 11.

At the end of the pre-defined period (e.g. N frames of the audio algorithm), the transmission of the reset code messages is stopped and normal operating mode is resumed.

According to an embodiment of the invention, the MC associated with user 13 sends an acknowledgment to the MC associated with User 1 via RTP packetizers 17 and 19. If the MC associated with User 1 does not receive such an acknowledgment message within a pre-defined time-out period (e.g. 1 sec), the above-described reset procedure is repeated.

### EXAMPLE 2

In the following example the system described in Example 1 is used. However, this time, the coordination procedure is requested by the decoder. This may be handled as follows: the MC associated with User 13 sends out an adjustment request message towards User 1 via RTP packetizers 17 and 19. Upon receipt of the adjustment request message, User 1 will initiate the procedure described above in example

However, this time, the reception of a reset code message is the acknowledgement of the previous adjustment request. In the absence of such an acknowledgment within a predetermined period (e.g. 1 sec), the MC associated with User 13 shall re-transmit the adjustment request message.

### EXAMPLE 3

Periodical Coordination

Following extended periods of connections without having to perform any algorithmic coordination s described hereinbefore, e.g. after about 1 hour, it may be desirable to perform such an algorithmic coordination.

If the near end DSP has not performed any algorithmic coordination for a period of a pre-defined length, e.g. 1 hour then the near end DSP shall detect a silence gap larger than 200 msec and shall initiate the algorithm coordination procedure as described above.

### EXAMPLE 4

Reset Initiated in Forward Direction

The following example describes an in-band explicit Algorithm Reset procedure for G.729/G.729 A Annex B operation that may be incorporated in recommendation H.225.

Upon detecting at the near end a that requires performing algorithm reset between a pair of encoder and decoder in the forward (TX) direction condition (as explained above), the following procedure is invoked:

Near End Transmitter Phase 1:

The encoder output is shut down for one algorithm frame. The encoder algorithm state is kept in its specified initial values during this shutdown period. The transmitter transmits a request towards the far end receiver to perform algorithmic reset—“ForwardReset_request”. In order to increase robustness, the encoder output may be shut down for N algorithmic frames and in which case the “ForewardReset_request” message will be issued N times.

Near End Transmitter Phase 2:

At the end of the shut down interval the encoder algorithm is released from its initial condition and starts to process the incoming PCM samples. One algorithm frame interval later, the encoder process will produce a frame containing either compressed active speech or silence insertion descriptor (SID) data. As will be appreciated by a person skilled in the art, this procedure described under Phase 2, shold preferably be carried out even if the “ForewardReset_request” message has not yet been received from the far end.

### EXAMPLE 5

Far End Receiver Phase 1:

Upon receipt of a “ForwardReset_request”, the receiver resets the decoder algorithm to its specified initial values. The receiver acknowledges the receipt of the “ForwardReset request” by instructing its local transmitter to send a “ForwardReset confirm” message.

Far End Receiver Phase 2:

Upon receipt of an algorithm frame (active speech or SID), the receiver releases the decoder from the initial state values and allow the processing of the incoming frame.

Near End Transmitter Phase 3 (Conditional)

If no “ForwardReset_confirm” message is received within a predefined period of time, T1 seconds after transmission of the first “ForwardReset_request”, the near end shall restart the forward reset procedure steps described above.

Reset Initiated in Backward Direction (2nd Scenario) Far End Phase 1:

Upon detecting a condition that requires algorithm reset in the backward direction (Rx direction), the far end instructs the corresponding transmitter to transmit a “BackwardReset_request” to the near end.

Near End Phase 1:

Upon receiving a “BackwardReset_request” from the far end, the near end shall initiate the steps as defined under the above 1st scenario.

Far End Phase 2 (Conditional):

If no “ForwardReset_request” is received within a predefined period of time, T1 seconds after transmitting a “BackwardReset_request”, the far end re-transmits the “BackwardReset request” to the near end.

It will be appreciated that the above-described methods may be varied in many ways, including, changing the order of steps, and the exact implementation used. It should also be appreciated that the above detailed description of methods, apparatus and systems are to be interpreted as including apparatus for carrying out the methods and ways of using the apparatus and systems.

The present invention has been described using non-limiting detailed descriptions of preferred embodiments thereof that are provided by way of example and are not intended to limit the scope of the invention. It should be understood that the features described with respect to one embodiment may be used with other embodiments and that not all embodiments of the invention have all of the features shown in a particular example. Variations of embodiments described may occur to persons skilled in the art without departing from the scope of the invention, and are thus encompassed by the present invention. Furthermore, the terms “comprise”, “include”, “have” and their conjugates, shall mean, when used in the description and claims, “including but not necessarily limited to”.

What is claimed is:

1. A method for use in transmission of audio signals over an IP network for coordinating the synchronous operation of a pair of interconnected audio encoder and audio decoder implementing at least one audio algorithm, by transmitting a message indicating that a synchronous reset of said audio algorithm is required.

2. A method according to claim 1, wherein said at least one audio algorithm is an algorithm having built-in silence suppression.

3. A method according to claim 1, operative in at least one of the following events:
i. a new communication link between the encoder and decoder is established;
ii. a link failure condition;
iii. a pre-defined period of time has lapsed since a previous synchronous reset took place provided event (i) and (ii) have not occurred within this pre-determined period of time.

4. A method according to claim 1, wherein the coordination of the synchronous operation of said audio encoder and said audio decoder is done by resetting said audio algorithm currently operative to its pre-defined values.

5. A method according to claim 3 wherein said audio algorithm is a member selected from a group comprising: G.723.1, G.729, G.729A, GSM full rate, GSM half rate and GSM enhanced rate.

6. A method according to claim 1, comprising:
i. establishing a path for a communication transmission;
ii. preventing the encoder from transmitting traffic information for a first pre-defined period of time;
iii. adjusting the encoder audio algorithm currently operative to its pre-defined values during said first pre-defined period of time;
iv. transmitting towards the decoder at least one message for synchronous reset during said first pre-defined period of time;
v. following the receipt of said at least one message for synchronous reset, adjusting the decoder audio algorithm currently operative to its pre-defined values; and
vi. allowing the encoder to re-process and re-transmit a new traffic information type of transmission after said first pre-defined period of time has lapsed.

6. A method according to claim 5, further comprising:
vii. in response to the receipt of said at least one message for synchronous reset by the decoder, transmitting an acknowledgement towards the encoder end;
Viii. repeating steps (iv) to (vii) in the event that this acknowledgment is not received within a second pre-defined period of time at the encoder's end.

7. A method according to claim 1, wherein said message for synchronous reset is a message transmitted using RTP packets.

8. A method according to claim 1, wherein said message for synchronous reset is initiated at the decoder end of the network.

9. An encoding/decoding device provided with means of implementing at least one audio algorithm, said encoding/decoding device is adapted for transmission of audio signals over an IP network, and is capable of resetting said at least one audio algorithm to its initial pre-defined values in response to a synchronous reset message received by a receiver associated therewith.

10. A device according to claim 9, wherein said at least one audio algorithm is an algorithm having built-in silence suppression.

11. A system adapted for transmission of audio signals over an IP network, comprising at least one pair of interconnected compressing/decompressing devices one of which is operative as an audio encoder and the other as an audio decoder and at least one message transmitter capable of transmitting a synchronous reset message, wherein said audio encoder is reset along with the transmission of said synchronous reset message and wherein said audio decoder is reset in response to receiving said synchronous reset message.
